(19) United States
(12) Patent Application Publication
(10) Pub. No.: US 2004/0245276 A1
(43) Pub. Date: Dec. 9, 2004

(54) Medicine feeder

(76) Inventors: Hiroshi Hashimoto, Toyonaka-shi (JP); Tasuku MInami, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/495,226

(22) PCT Filed: Nov. 13, 2002
(86) PCT No.: PCT/JP02/11824

(30) Foreign Application Priority Data
Nov. 14, 2001 (JP) 2001-348895

(51) Int. Cl. B65G 59/00; G07F 11/16; B65H 3/00

(52) U.S. Cl. 221/265

(57) ABSTRACT

The invention provides a tablet feeder that is simple in construction and yet capable of accurately preventing drawbacks from occurring due to jamming of medicine or the like. A motor 6 installed on a case support block 3 is driven to rotate a rotor 9 disposed in a medicine receiving case 1 through a plurality of gears. The tablets received in the medicine receiving case 1 are held in the pockets 10 of the rotor 9 and is moved to the discharge section 11 to discharge tablets from the discharge section 11. The gearing is composed of a driving gear 7 connected to the rotary shaft of the motor 6, and a driven gear 13 meshing with the driving gear 7. Installed in either of the power transmission paths extending from the motor 6 to the rotor 9 through the two gears 7, 13 is a power cut-off section 15, 17 that cuts off the power from the motor 6 when a force of a predetermined value or above acts on the rotor 9.

### TECHNICAL FIELD

The present invention relates to a medicine feeder.

### BACKGROUND ART

Conventionally, there has been a medicine feeder comprising a case supporting base provided with a motor and a medicine containing case removably mounted on the case supporting base. In this kind of medicine feeder, when the motor is driven to rotate a rotor provided in the medicine containing case via a plurality of gears, the medicine held in pocket portions formed on the rotor can be discharged from a discharge portion of the case supporting base.

In the conventional construction, however, when a medicine is jammed and the rotation of the rotor is prevented, there is a risk that the medicine may be damaged or the motor may suffer burnout.

### DISCLOSURE OF INVENTION

Thus, a problem of the present invention is to provide a medicine feeder that is simple in construction and yet capable accurately preventing drawbacks from occurring due to jamming of the medicine or the like.

As means for solving the aforementioned problem, the present invention provides a medicine feeder in which a motor provided in a case supporting base is driven to rotate a rotor in a medicine containing case supported in the case supporting base via a plurality of gears; medicine contained in the medicine containing case are held in each pocket portion of the rotor and are moved to a discharge portion of the case supporting base to discharge the medicine from the discharge portion, wherein:

said plurality of gears are composed of a driving gear connected to a rotation shaft of the motor and a driven gear engaging with the driving gear; and

a power cut-off portion is provided in a power transmission passage reaching the rotor from the motor through the both gears so that a power from the motor is cut off when a braking force of more than a predetermined value acts on the rotor.

According to the above construction, in a case that medicine such as tablets, capsules and so on is jammed and rotation of the rotor is prevented, the power cut-off portion does not allow a drive power from the motor to be transmitted to the rotor, whereby any disadvantages such as damage of medicine, burnout of motor and so on would not occur.

It is preferable in that a desired effect can be obtained in spite of simple construction that the power cut-off portion comprises a friction generating member provided between the rotor and the driven gear.

It is preferable in that damage of medicine, burnout of motor and so on can be reliably prevented considering properties of the medicine or so that a friction force generated by the friction generating member is adjustable.

The friction generating member may comprise a ring member having an annular shape, the ring member being made of synthetic resin material.

The power cut-off portion may comprise indentations provided on either one of the rotor and the driven gear and protrusions provided on the other, the protrusions engaging with the indentations, whereby the engagement of the indentation and the protrusions is released when a braking force of more than a predetermined value acts on the rotor.

According to the present invention, as the power cut-off portion is provided in the power transmission passage reaching the rotor from the motor, it is possible to reliably preventing any disadvantages such as damage of the medicine, burnout of the motor and so on even if medicine jam or so disables the motor from rotating.

### BRIEF DESCRIPTION OF DRAWINGS

FIG. 1 is a front view of a tablet feed apparatus provided with a tablet feeder according to an embodiment of the present invention;

FIG. 2 is an exploded perspective view of the tablet feeder according to an embodiment of the present invention;

FIG. 3 is a bottom view of the tablet containing case shown in FIG. 2;

FIG. 4 is a partly sectional view of a rotor of the tablet feeder shown in FIG. 2;

FIG. 5 is a partly sectional view of a variation of the tablet feeder of FIG. 4;

FIG. 6 is a partly sectional view of an another variation of the tablet feeder of FIG. 4;

FIG. 7 is a partly sectional view of a rotor of the tablet feeder according to an another embodiment of the present invention;

FIG. 8 is a partly enlarged sectional view of the rotor of FIG. 7; and

FIG. 9 is a partly sectional view of a variation of the tablet feeder of FIG. 7.

### BEST MODE FOR CARRYING OUT THE INVENTION

Hereinafter, embodiments according to the present invention will be explained with reference to the accompanied drawings.

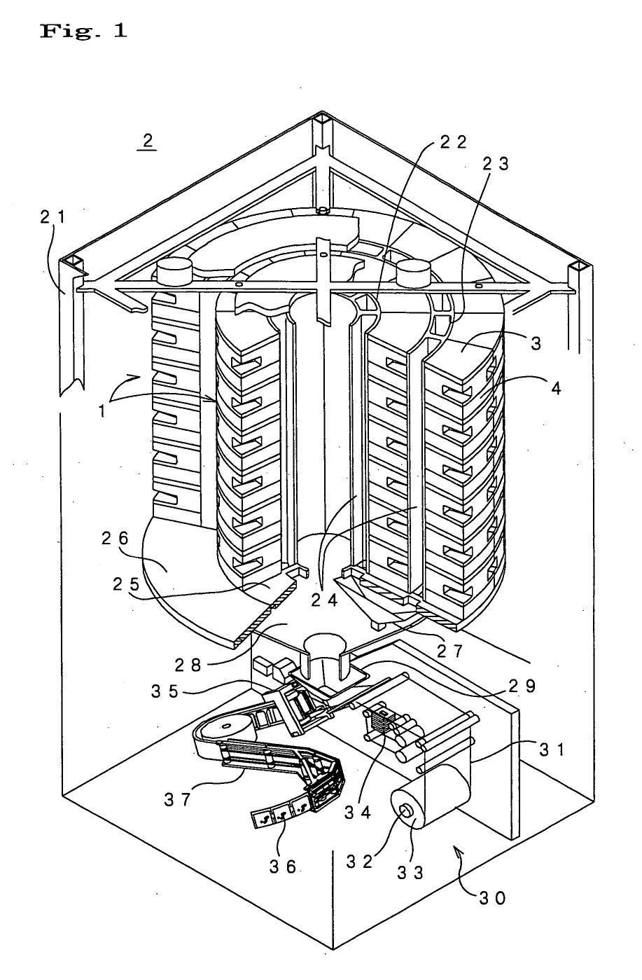

FIG. 1 shows a tablet feed apparatus 2 having a plurality of tablet feeders 1 according to the present invention.

In the tablet feed apparatus 2, inner and outer double drums 22, 23 are contained inside a cabinet 21 with the upper and lower end rotatably supported. On the outer surface of each drum 22, 23 are provided the plurality of tablet feeders 1, while on the inner surface are formed a plurality of drop guide passages 24 in which the tablets discharged from each tablet feeder 1 provided in a vertical direction drop. Beneath the drums 22, 23 are provided lower plates 25, 26 having shutter not shown for temporarily receiving the tablets dropping from each drop guide passage 24. Under the lower plates 25, 26 are provided small hoppers 27 correspondingly to each drop guide passage 24. Each small hopper 27 receives the tablets dropping from the drop guide passages 24 of the inner drum 22 and the drop guide passages 24 of the outer drum 23. Under the small hoppers 27 is provided a collection hopper 28 for collecting the tablets dropping from the small hoppers 27. Beneath the collection hopper 28 is provided a packing hopper 29. Under the packing hopper 29 is provided a tablet packing section 30.

The tablet packing section 30 comprises a roll 33 comprising a wound packing sheet 31 and removably mounted on a roll shaft 32, a printer 34 for printing information such as patient name, tablet name, dosing time, dose and the like on the packing sheet 31 reeled out from the roll 33, a triangle plate not shown in detail for folding the packing sheet 31 into two so that the tablets discharged from the packing hopper 29 can be introduced, a pair of heater rollers 35 for sealing the packing sheet 31 with the tablets introduced, and a conveyor 37 for conveying the medicine package belt 36, which has passed through the heater rollers 35 and has been discharged in an obliquely lower direction, in an obliquely upper direction to direct it to a discharge port not shown.

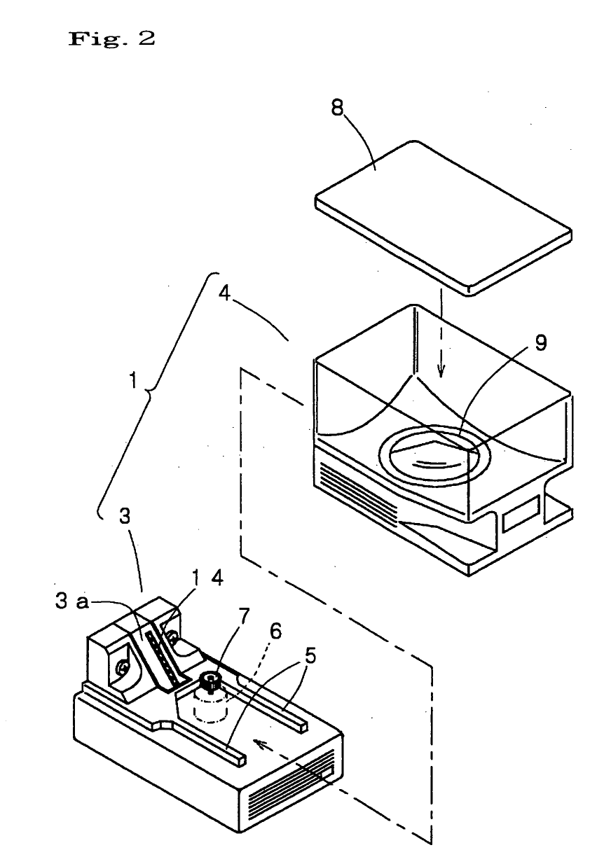

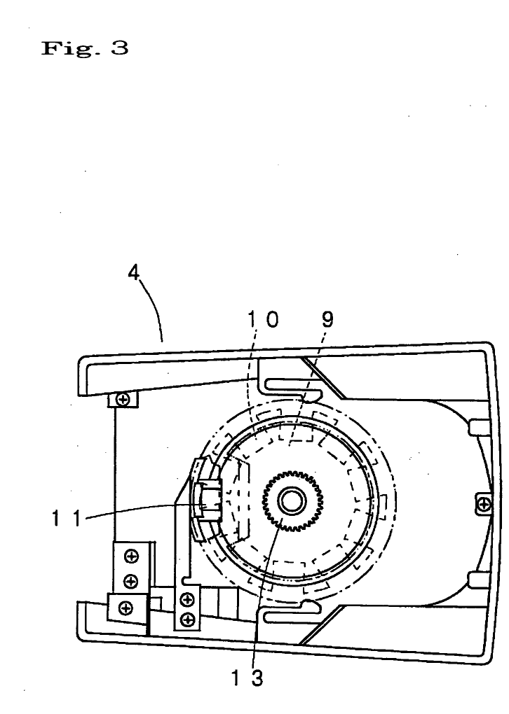

The tablet feeder 1, as shown in FIG. 2, is constituted by a case supporting base 3 provided on the tablet feed apparatus 2 and a tablet containing case 4 removably mounted on the case supporting base 3.

The case supporting base 3 is provided with guide portions 5 on the upper surface side by side with a predetermined distance. Inside the case supporting base 3 is housed a motor 6 which is driven and controlled based on a control signal from a control unit not shown. The rotation shaft of the motor 6 protrudes from the upper surface of the case supporting base 3. On the protruding portion is integrated a driving gear 7. The case supporting base 3 is formed with a discharge passage 3a in which a sensor 14 for detecting the tablets passing through it.

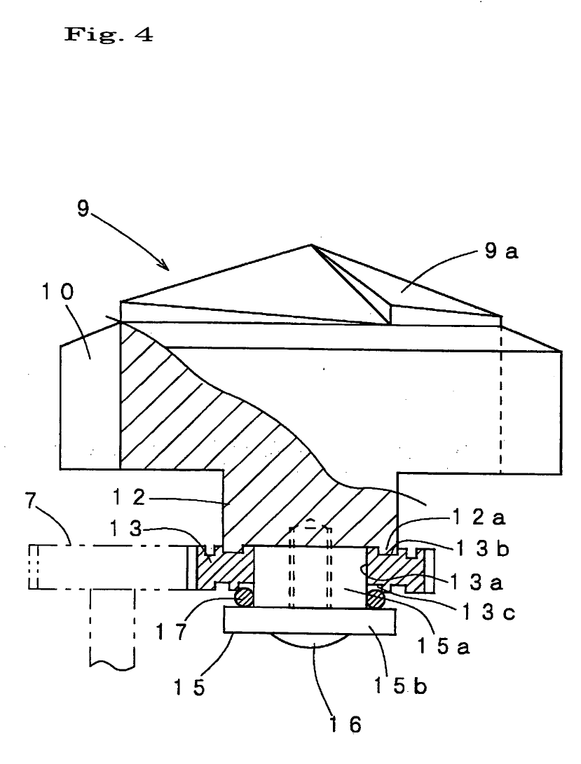

The tablet containing case 4 has a substantially box-like shape, the upper surface of which can be opened and closed by a lid 8. The upper surface of the bottom wall of the tablet containing case 4 is formed in a substantially conical shape, in which a rotor 9 is provided. The upper surface of the rotor 9, as shown in FIG. 4, has a substantially conical shape and is formed with step portions 9a which gradually protrude at equally spaced three portions in a circumferential direction. On the outer surface of the rotor, pocket portions 10 each having a groove shape extending in a vertical direction are formed at a plurality of positions spacing with an equal angle. The pocket portion 10 has a width and depth possible to hold only one tablet contained in the case 4. On the bottom wall of the tablet containing case 4 is formed with a discharge port 11. The discharge port 11 has a width dimension that includes only one of the pocket portions 10 of the rotor 9. On the central portion of the bottom surface of the rotor 9 is provided a rotation shaft 12. The rotation shaft 12 protrudes from the lower surface of the bottom wall of the tablet containing case 4. On the outer periphery of the end surface of the rotation shaft 12 is formed an annular protruding portion 12a.

To the rotation shaft of the rotor 9, a driven gear 13 is attached by an attachment member 15. The attachment member 15 comprises a shaft portion 15a and a flange portion 15b and is fixed on the rotation shaft 12 of the rotor 9 with a screw 16 inserted into the central portion of the attachment member 15. The shaft portion 15a is inserted into a central aperture 13a of the driven gear 13 to rotatably support the driven gear 13. The flange portion 15b supports the driven gear 13 between the flange portion 15b and the end surface of the rotation shaft of the rotor 9 via a ring member 17. The ring member 17 comprises, for example, an O-ring made of synthetic resin and generates a predetermined friction force in accordance with a gap between the rotor 9 and the attachment member 15, i.e., a press contact force with the ring member 17. A friction force is set so that when tablet jam prevents the rotor 9 from rotating, a slip can be caused between the ring member 17 and the rotor 9 or the attachment member 15 before the tablet suffers damages such as break or split. The driven gear 13 is made of synthetic resin material. On the upper surface of the driven gear 13 is formed an annular groove 13b with which the annular protruding portion 12a formed on the rotation shaft 12 of the rotor 9 rotatably engages. On the lower opening edge portion is formed an annular recess portion 13c in which the ring member 17 is positioned. Annular grooves formed on the outer periphery of the upper and lower surfaces of the driven gear 13 is provided as so called a relief in order to make the thickness equal.

Operation of the tablet feeder 1 of the above construction will be explained hereinafter.

In accordance with a prescription data, the tablet feeder 1 containing the tablets concerned is driven. That is to say, when the motor 6 is driven, a drive power is transmitted to the driven gear 13 via the driving gear 7. To the attachment member 15 from the driven gear 13, the drive power is transmitted by a friction force against the ring member 17 positioned between the both members. Thus, rotation of the driving gear 7 allows the attachment member 15, the driven gear 13 and the rotor 9 to rotate via the ring member 17 so that the tablets held in the pocket portions 10 can be discharged from the discharge passage 3a one after another. The discharged number of the tablets is counted by the sensor 14 provided in the discharge passage 3a. When the discharged number comes up to a predetermined number, the motor 6 is stopped.

For example, when a tablet jam prevents the rotor 9 from rotating and a braking force acts on the rotor 9, a slip is caused between the attachment member 15 and the driven gear 13 so that a drive power of the motor 6 is cut-off. Therefore, no excessive load acts on the jammed tablet from the rotor 9 and the tablet does not suffer damages such as break or split.

The tablets discharged form each tablet feeder 1 fall on the lower plates 25, 26 through the drop guide passages 24. When a shutter not shown is opened at a predetermined timing, the tablets are introduced into the tablet packing section 30 through the small hoppers 27, the collection hopper 28 and the packing hopper 29 and packed by one dose in the tablet packing section 30.

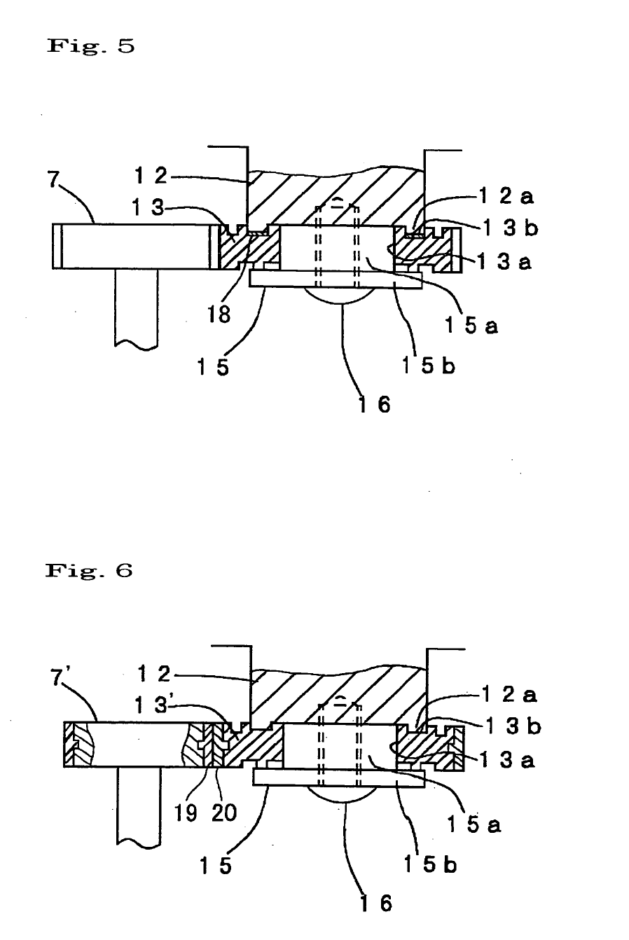

In the aforementioned embodiment, the O-ring is used as the ring member 17 but the shape, material and so on of the ring member 17 is not limited to this. For example, as shown in FIG. 5, it is also possible to stick a ling-like rubber sheet 18 etc. on at least one of the contact surfaces between the driven gear 13 and the rotation shaft of the rotor 9 to change a friction coefficient.

Furthermore, in the aforementioned embodiment, the ring member 17 etc. is interposed between the rotor 9 (and the attachment member 1) and the driven gear 13 to cause a slip, though the same construction may be used between the rotation shaft of the motor 6 and the driving gear 7. Also, in stead of the driving gear 7 and the driven gear 13, as shown in FIG. 6, rollers 7′, 13′ with rubbers 19, 20 attached on the outer surface thereof may be used so that the rubbers can come into contact with each other to cause a slip therebetween.

Furthermore, in the aforementioned embodiment, the attachment member 15 is attached by means of the screw 16, though it is preferable in that the friction force against the ring member 17 can be adjustable to form a mail screw on the end outer surface of the shaft portion 15a of the attachment member 15 and directly screw it into the rotor 9.

In the aforementioned embodiment, as a power cut-off means of the present invention, a friction forming member such as the ring member 17, the rubber sheet 18, the rubbers 19, 20 and so on is used, though indentations may be provided on either one of the rotor 9 (or attachment member 15) and the driven gear 13 while protrusions that engage with the indentation may be provided on the other so that when a braking force of more than a predetermined value acts on the rotor 9, engagements of the indentations and the protrusions are released and the drive power is cut-off.

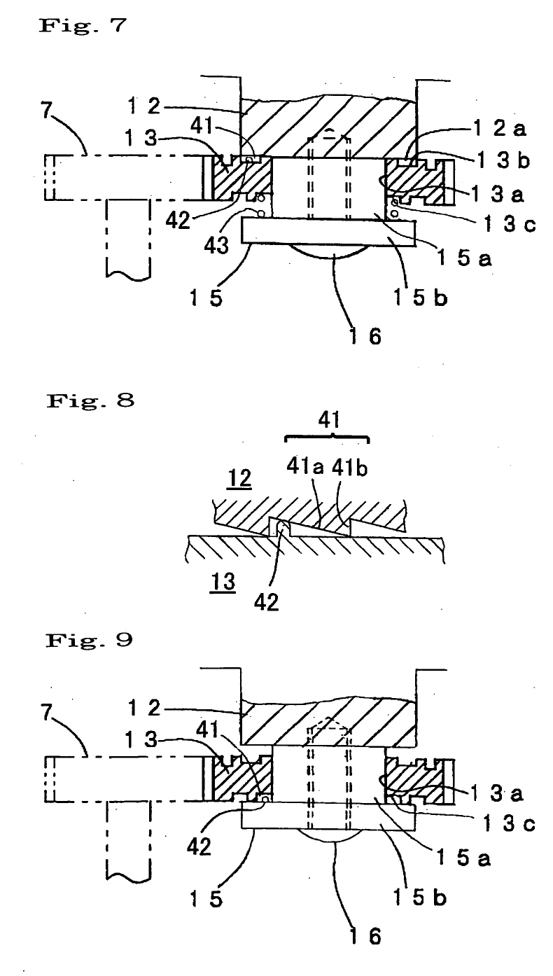

For example, as shown in FIG. 7, indentations 41 are formed on the annular protruding portion 12a of the rotation shaft 12 of the rotor 9 while protrusions 42 which engage with the indentations 41 may be formed on the annular groove 13b of the driven gear 13. A spring 43 may be provided between the annular recess portion 13c of the driven gear 13 and the flange portion 15b of the attachment member 15 to urge the driven gear 13 upward so that the engagement of the indentations 41 and the protrusions 42 can be maintained. The indentations 41, as shown in FIG. 8, comprise a plurality of slopes 41a and step portions 41b which are continuously formed in a circumferential direction. In normal operation, the engagement of the indentations 41 and the protrusions 42 allows the drive power of the motor 6 to be transmitted to the rotor 9 from the driven gear 13. When a tablet jam causes a braking force of more than a predetermined value to act on the rotor 9, the protrusions 42 slide on the slops of the indentations 41 and overpass the step portions 41b as the driven gear 13 moves downward, whereby the drive power of the motor 6 can be cut-off.

Moreover, as shown in FIG. 9, indentations 41 may be formed on the annular recess portion 13c of the driven gear 13 while protrusions 42 which engage with the indentations 41 may be formed on the flange portion 15b of the attachment member 15. In this case, as the engagements of the indentation 41 and the protrusions 42 are maintained by the weight of the driven gear 13, the spring as shown in FIG. 7 is not necessary.

In the aforementioned embodiment, although the construction of discharging the tablet as medicine has been described, other solid type of medicine such as capsule can be dealt with by the same construction.

1. A medicine feeder in which a motor provided in a case supporting base is driven to rotate a rotor in a medicine containing case supported in the case supporting base via a plurality of gears; medicine contained in the medicine containing case are held in each pocket portion of the rotor and are moved to a discharge portion of the case supporting base to discharge the medicine from the discharge portion, characterized in that:
said plurality of gears are composed of a driving gear connected to a rotation shaft of the motor and a driven gear engaging with the driving gear; and
a power cut-off portion is provided in a power transmission passage reaching the rotor from the motor through the both gears so that a power from the motor is cut off when a braking force of more than a predetermined value acts on the rotor.

2. The medicine feeder as in claim 1, characterized in that the power cut-off portion comprises a friction generating member provided between the rotor and the driven gear.

3. The medicine feeder as in claim 2, characterized in that a friction force generated by the friction generating member is adjustable.

4. The medicine feeder as in claim 2, characterized in that the friction generating member comprises a ring member having an annular shape, the ring member being made of synthetic resin material, a shaft portion fixed on the rotor, the shaft portion rotatably supporting the driven gear, and a flange portion for supporting the ring member between the flange portion and the driven gear.

5. The medicine feeder as in claim 1, characterized in that the power cut-off portion comprises indentations provided on either one of the rotor and the driven gear and protrusions provided on the other, the protrusions engaging with the indentations, whereby the engagement of the indentation and the protrusions is released when a braking force of more than a predetermined value acts on the rotor.

6. The medicine feeder as in claim 3, characterized in that the friction generating member comprises a ring member having an annular shape, the ring member being made of synthetic resin material, a shaft portion fixed on the rotor, the shaft portion rotatably supporting the driven gear, and a flange portion for supporting the ring member between the flange portion and the driven gear.
